(19) United States
(12) Patent Application Publication
(10) Pub. No.: US 2005/0134944 A1
(43) Pub. Date: Jun. 23, 2005

(54) Image capturing device with duplex scan function and method therefor

(76) Inventor: Yen-Cheng Chen, Hsinchu (TW)

Correspondence Address: RABIN & Berdo, PC, 1101 14TH STREET, NW, SUITE 500, WASHINGTON, DC, 20005, US

(21) Appl. No.: 11/013,740

(22) Filed: Dec. 17, 2004

(30) Foreign Application Priority Data
Dec. 18, 2003 (TW) 92136043

(51) Int. Cl. H04N 1/46

(52) U.S. Cl. 358/513

(57) ABSTRACT

An image capturing device with duplex scan function for scanning a to-be-scanned document and a method therefor. A first image sensor senses the a first optical signal unit of a first side data of the to-be-scanned document and outputs the generated first analog signal unit. A second image sensor senses a second optical signal unit of a second side data of the to-be-scanned document and outputs the generated second analog signal unit. An ASIC controls exposure timings of the first image sensor and second image sensor. A multiplexer alternately selects the first analog signal unit or the second analog signal unit. The ASIC sequentially and alternately outputs a first digital signal unit and a second digital signal unit, converted from the first analog signal unit and the second analog signal unit by an A/D converter.

This application claims the benefit of Taiwan application Serial No. 92136043, filed Dec. 18, 2003, the subject matter of which is incorporated herein by reference.

### BACKGROUND OF THE INVENTION

1. Field of the Invention

The invention relates in general to an image capturing device and a method therefor, and more particularly to an image capturing device with duplex scan function and a method therefor.

2. Description of the Related Art

With the new and rapid development of scanners, users have set a higher standard for the image scanning qualities. Recently, due to the maturity of the scanning technology and the full development of the high-speed transmission interface, scanners have become quite popular among image-related workers and home users, and the popularity of scanners today is much greater than ever. The main functions of scanners are to capture images and to convert the content of an original document into an electric file so as to enable the user to easily distribute, file and keep the data. Beside the continual improvements in image resolutions and in scan quality, scanning speed as well has gradually advanced with the introduction and the breakthrough in the automatic sheet-feeding technology and the duplex image capturing technology.

FIG. 1 is a systematic block diagram showing a conventional scanner with duplex scan function. The conventional scanner with duplex scan function adopts two scanning modules, which are respectively disposed on a top side and on a bottom side of a transparent platen so as to perform the duplex scan (One Pass Duplex Scanning) operation on a document placed on the transparent platen. As shown in FIG. 1, the first scanning module for scanning a first side data of the document is disposed on the bottom side of the transparent platen and mounted on the scanner body 100. The first scanning module includes a first image sensor 112, a first A/D converter 114 and a first memory 116. The second scanning module for scanning a second side data of the document is disposed on the top side of the transparent platen and mounted on the ADF (Automatic Document Feeder) 200. The second scanning module includes a second image sensor 212, a second A/D converter 214, and a second memory 216.

When the image capturing process is being performed, the ADF 200 feeds the to-be-scanned document through a region between the first image sensor 112 in the scanner body 100 and the second image sensor 212 of the ADF 200, so that the first image sensor 112 and the second image sensor 212 can read the first side data and the second side data of the to-be-scanned document. The first image sensor 112 and the second image sensor 212 respectively read the first side data and the second side data to generate analog signals, which are then converted by the first A/D converter 114 and the second A/D converter 214 into digital signals that may be processed in a digital manner.

In the conventional data output method, an ASIC (Application Specific Integrated Circuit) 102 first processes the digital signal of the first side data, and the processed digital signal of the first side data is transmitted to a computer system 106 via a bus 104. During this process, the digital signal of the second side data that is converted by the second A/D converter 214 is temporarily stored in the second memory 216. After the first side data has been completely processed, the digital signal of the second side data that has been temporarily stored in the second memory 216 is processed. As a result, the memory of the scanner having two scanning modules for temporarily storing the scanning data must have a memory capacity greater than one page of data. Thus, not only the scanning speed cannot be increased, but the cost is increased.

### SUMMARY OF THE INVENTION

It is therefore an object of the invention to provide an image capturing device with duplex scan function which uses a exposure timing control method and transmits data in subdivisions.

The invention achieves the above-identified object by providing an image capturing device with duplex scan function for scanning a to-be-scanned document, which includes a first side data and a second side data. The image capturing device includes a first image sensor, a second image sensor, a multiplexer, an A/D converter, an ASIC and a memory. The first image sensor senses a first optical signal unit of a first optical signal of the first side data and generate a corresponding first analog signal unit of a first analog signal, wherein a plurality of the first optical signal units constitutes the first optical signal and a plurality of the first analog signal units constitutes the first analog signal. The second image sensor senses a second optical signal unit of a second optical signal of the second side data and generates a corresponding second analog signal unit of a second analog signal, wherein a plurality of the second optical signal units constitutes the second optical signal and a plurality of the second analog signal constitutes the second analog signal. The multiplexer selects the first analog signal unit or the second analog signal unit. The A/D converter converts the selected the first analog signal unit into a first digital signal unit, or the selected the second analog signal unit into a second digital signal unit. The ASIC controls the exposure timings of the first image sensor and the second image sensor, enabling the first image sensor and the second image sensor to sequentially and alternately output the first analog signal unit and the second analog signal unit. The memory temporarily stores the first digital signal unit and the second digital signal unit.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a systematic block diagram showing a conventional scanner with duplex scan function.

FIG. 2 is a systematic block diagram showing an image capturing device with duplex scan function according to the invention.

FIG. 3 is a schematic illustration showing the operation of the image sensor.

FIG. 4A is a schematic illustration showing an exposure timing control of an image capturing device with duplex scan function according to a first embodiment of the invention.

FIG. 4B is a schematic illustration showing an exposure timing control of an image capturing device with duplex scan function according to a second embodiment of the invention.

FIG. 4C is a schematic illustration showing an exposure timing control of an image capturing device with duplex scan function according to a third embodiment of the invention.

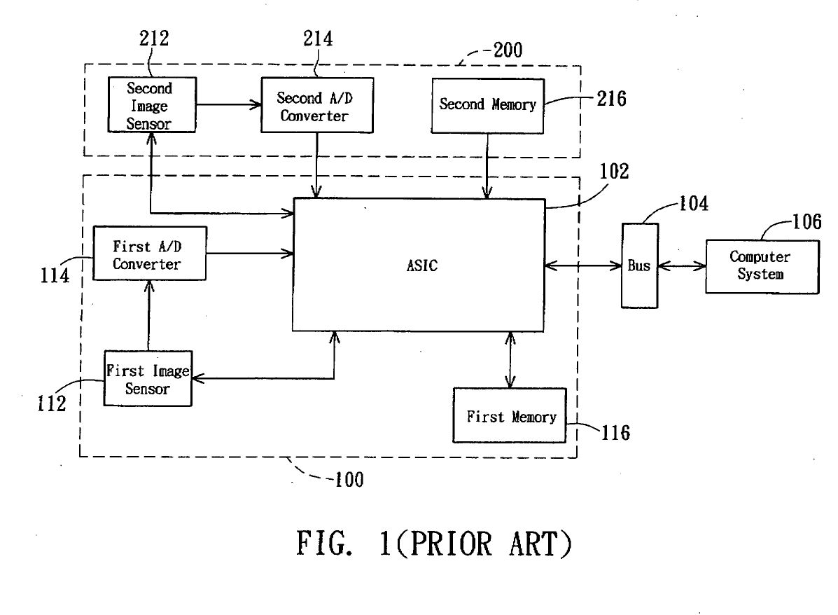

### DETAILED DESCRIPTION OF THE INVENTION

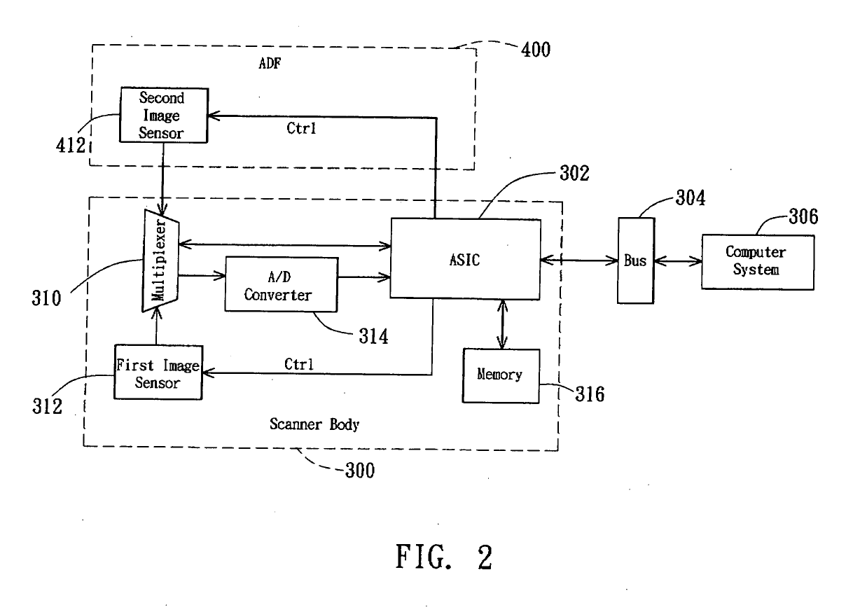

FIG. 2 is a systematic block diagram showing an image capturing device with duplex scan function according to the invention. As shown in FIG. 2, the image capturing device with duplex scan function includes a first image sensor 312, a second image sensor 412, a multiplexer 310, an A/D converter 314, an ASIC 302 and a memory 316. The first image sensor 312 is disposed in the scanner body 300, and the second image sensor 412 is disposed in the ADF (Automatic Document Feeder, ADF) 400. When the image capturing device starts to capture the images of a to-be-scanned document, the ADF 400 feeds the to-be-scanned document through between the first image sensor 312 in the scanner body 300 and the second image sensor 412 in the ADF 400 so that the first image sensor 312 and the second image sensor 412 can read a first side data and a second side data of the to-be-scanned document. The first image sensor 312 senses a first optical signal unit of a first optical signal of the first side data and generates a corresponding first analog signal unit of a first analog signal for outputting the first analog signal in subdivisions. The second image sensor 412 senses a second optical signal unit of a second optical signal of the second side data and generate a corresponding second analog signal unit of a second analog signal for outputting the second analog signal in subdivisions.

The invention discloses a method for outputting data in subdivisions by using the ASIC 302 to perform the exposure timing controls of the first image sensor 312 and the second image sensor 412. The method is to alternately output the analog signal units. The analog signal unit may contain data of a scan line. The multiplexer 310 selects and transmit the first analog signal unit or the second analog signal unit to the A/D converter 314. Then, the A/D converter 314 converts the received first analog signal unit into a first digital signal unit, or converts the received second analog signal unit into a second digital signal unit. The ASIC 302 controls the exposure timings of the first image sensor 312 and the second image sensor 412, enabling the first image sensor 312 and the second image sensor 412 to sequentially and alternately output the first analog signal unit and the second analog signal unit, and processes the first digital signal unit and the second digital signal unit. At last, the bus 304 transmits the processed digital signals to the computer system 306. The memory 316 serving as a data buffer temporarily stores the first digital signal or the second digital signal. If the transmission speed of the bus 304 is higher than or equal to the speed at which the optical signal units are converted into the analog signal units and transmitted to the A/D converter 314, the memory 316 is then not needed. Compared to the prior art, the signal-output method of the invention is to use the ASIC 302 to perform the exposure timing controls on the first image sensor 312 and the second image sensor 412. Thus, the analog signals units of the first side data and the second side data units are sequentially and alternately outputted, and it is unnecessary to provide a memory with a memory space of more than one page. Consequently, the invention can correspondingly reduce the memory space for temporarily storing the scanning data or even eliminate the memory 316. In addition, the invention does not require two A/D converters; hence, the cost may be greatly reduced.

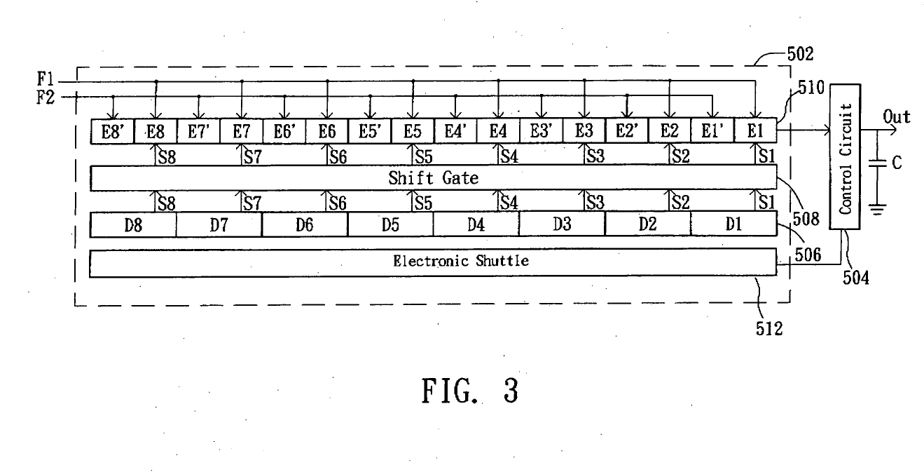

FIG. 3 is a schematic illustration showing the operation of the image sensor. As shown in FIG. 3, the image sensor receives an optical signal and detects the magnitude of the optical signal thereof to generate an analog signal corresponding to the optical signal. In FIG. 3, a CCD (Charge-Coupled Device) sensor device serves as the image sensor of the invention, and the operation thereof is described as follows. The CCD sensor device 502 mainly includes a photo sensor set 506, a shift gate 508 and a shift register 510. The CCD sensor device 502 with the resolution of 2400 dpi (dots per inch) will be described in the following. If the CCD sensor device 502 can be used to read the document having the width of 8 inches, the photo sensor set 506 thereof includes 2400×8=19200 photo sensors, wherein only eight sensors D1 to D8, for example, are illustrated in the drawing. The photo sensors convert the sensed optical signals into signal charges. The photo sensor may be a photo diode. The shift gate 508 controls the transfer of the signal charges. After the exposure of the photo sensors is finished, the shift gate 508 is turned on such that the signal charges are transferred to the shift register 510. The shift register 510 may be a two-phase shift register 510, and the shift register 510 for sensing the document having a width of 8 inches in a 2400 dpi manner includes 38400 CCD elements, wherein only 16 CCD elements, such as the CCD elements E1 to E8 and E1′ to E8′ corresponding to the photo sensors D1 to D8, are illustrated in the drawing. The CCD elements are alternately disposed and controlled by the phase signals F1 and F2. Then, under the control of the phase signals F1 and F2, the signal charges stored in the CCD elements are sequentially shifted out. In FIG. 3, only 8 photo sensors D1 to D8 among the 19200 photo sensors are described, wherein the photo sensors D1 to D8 can generate signal charges S1 to S8, which may be transferred to the CCD elements E1 to E8. The control circuit 504 controls the signal charges S, which are outputted from the shift register 510, to be sequentially stored in the capacitor C to generate the analog output signal.

In order to enable the analog signals of the first side data and the second side data corresponding to the first image sensor 312 and the second image sensor 412 to be sequentially and alternately outputted in subdivisions, the invention performs the exposure timing controls on the first image sensor 312 and the second image sensor 412. The control method is determined according to the relationship between the exposure time of the photo sensors and the shift-out time of the signal charges.

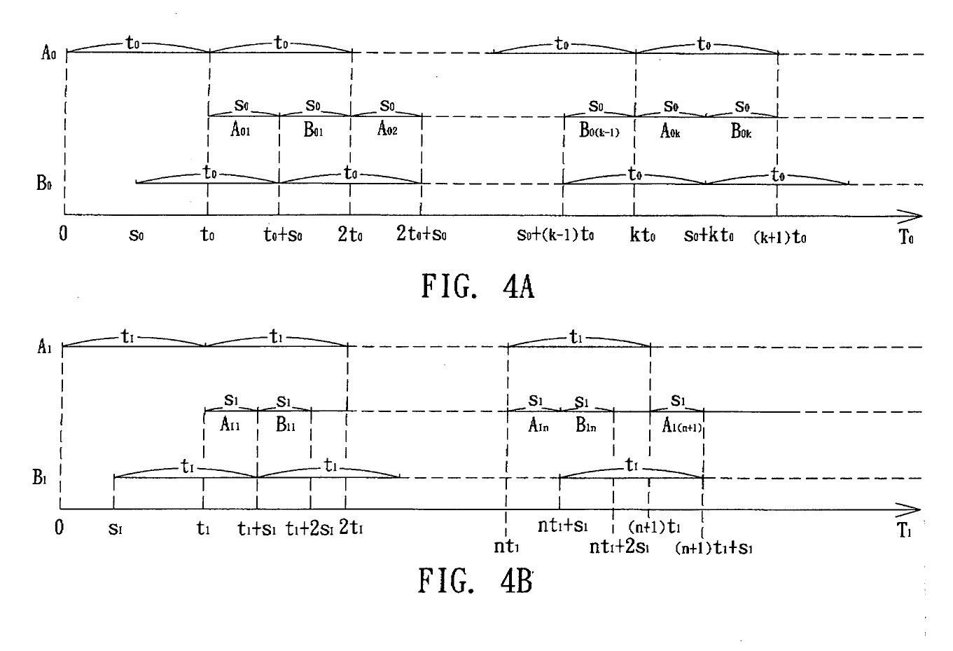

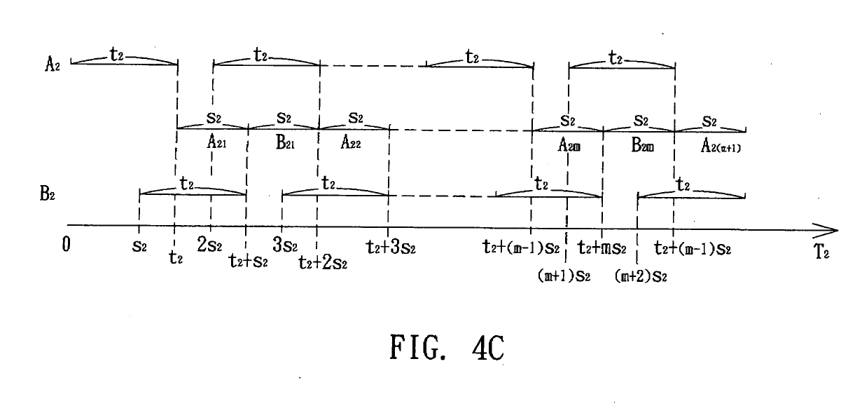

FIG. 4A is a schematic illustration showing an exposure timing control of an image capturing device with duplex scan function according to a first embodiment of the invention. As shown in FIG. 4A, the exposure time (t₁) of the sensor of the image capturing device of the first embodiment equals twice the shift-out time (s₁) for the signal charges, that is, t₁=2s₁. When the image is being captured, the first image sensor 312 and the second image sensor 412 in the first optical module AO and the second optical module Bo respectively sense the first side data and the second side data of the to-be-scanned document, and the ASIC 302 performs the exposure timing controls on the first image sensor 312 and the second image sensor 412 such that the analog signal units of the first side data and the second side data can be sequentially and alternately outputted. First, the first image sensor 312 senses the 1^{st} first optical signal unit of the first side data at T₀=0. Next, the second image sensor 412 senses the 1^{st} second optical signal unit of the second side data at T₀=s₀. At T₀=t₀, the first image sensor 312 finishes sensing the 1^{st} first optical signal unit, starts to shift out the 1^{st} first signal charge A₀₁, and continues to sense the 2^{nd} first optical signal unit of the first side data. At T₀=t₀+s₀, the first image sensor 312 finishes shifting out the 1^{st} first signal charge A₀₁. At this time, the second image sensor 412 just finishes sensing the 1^{st} second optical signal unit. Then, the second image sensor 412 starts to shift out the 1^{st} second signal charge B₀₁, and continues to sense the 2^{nd} second optical signal unit of the second side data. At T₀=2t₀, the second image sensor 412 finishes shifting out the 1^{st} second signal charge B₀₁, and finishes sensing the 2^{nd} first optical signal unit of the first side data. Then, the first image sensor 312 shifts out the 2^{nd} first signal charge A₁₂, and continues to sense the next optical signal unit.

In the first embodiment, the exposure time (t₁) of the sensor of the image capturing device equals twice the shift-out time (s₁) of the signal charge, so two signal charges can be shifted out within the exposure time of one optical signal unit. In this case, the first image sensor 312 and the second image sensor 412 respectively sense the first optical signal units and second optical signal units, and enables the first signal charge units and second signal charge units to be continuously, sequentially, and alternately outputted without being temporarily stored in the memory.

FIG. 4B is a schematic illustration showing an exposure timing control of an image capturing device with duplex scan function according to a second embodiment of the invention. As shown in FIG. 4B, the exposure time (t₁) of the sensor of the image capturing device of the second embodiment is longer than twice the shift-out time (s₁) of the signal charge, that is, t₁>2s₁. When the image is being captured, the first image sensor 312 and the second image sensor 412 in the first optical module A1 and the second optical module B₁ respectively sense the first side data and the second side data of the to-be-scanned document in a disperse manner, and the ASIC 302 performs the exposure timing controls on the first image sensor 312 and the second image sensor 412, such that the analog signal units of the first side data and the second side data can be sequentially and alternately outputted. First, the first image sensor 312 senses the 1^{st} first optical signal unit of the first side data at T₁=0. Next, the second image sensor 412 senses the ₁ st the second optical signal unit of the second side data at T₁=S₁. At T₁=s₁, the first image sensor 312 finishes sensing the 1^{st} first optical signal unit, starts to shift out the 1^{st} first signal charge A₁₁, and continues to sense the 2^{nd} first optical signal unit of the first side data. At T₁=t₁+s₁, the first image sensor 312 finishes shifting out the 1^{st} first signal charge A₁₁. At this time, the second image sensor 412 just finishes sensing the 1^{st} the second optical signal unit. Then, the second image sensor 412 shifts out the 1^{st} second signal charge B₁₁, and continues to sense the 2^{nd} second optical signal unit of the second side data. At T₁=t₁+2s₁, the second image sensor 412 finishes shifting out the 1^{st} second signal charge B₁₁, but the exposure operations of the 2^{nd} first optical signal unit of the first side data and the 2^{nd} second optical signal unit of the second side data have not been finished yet, so no signal charge is shifted out at T₁=[t₁+2s₁,2t₁]. The 2^{nd} first signal charge A₁₂ is not shifted out and sensing the next optical signal unit is not continued until T₁=2t₁ when the first image sensor 312 finishes sensing the 2^{nd} first optical signal unit of the first side data.

In the second embodiment, the exposure time (t₁) of the sensor of the image capturing device is longer than the shift-out time (s₁) of the signal charges, so two signal charges can be shifted out within the exposure time of one optical signal unit. In this case, the first image sensor 312 and the second image sensor 412 respectively and continuously sense the first optical signal unit and second optical signal, shift out the n^{th} first signal charge A₁ₙ at T₁=[nt₁,nt₁+s₁], shift out the n^{th} second signal charge B₁ₙ at T₁=[nt₁+s₁,nt₁+2s₁], and do not shift out any signal charge at T₁=[nt₁+2s₁,(n+1)t₁]. That is, the (n+1)^{th} first signal charge A₁₍ₙ₊₁₎ cannot be shifted out after the time of t₁−2s₁ has elapsed.

FIG. 4C is a schematic illustration showing an exposure timing control of an image capturing device with duplex scan function according to a third embodiment of the invention. The exposure time (t₂) of the sensor of the image capturing device of the second preferred embodiment is smaller than twice the shift-out time (s₂) of the signal charges, that is, t₂>2s₂. When the image is being captured, the first image sensor 312 and the second image sensor 412 in the first optical module A₂ and the second optical module B₂ respectively sense the first side data and the second side data of the to-be-scanned document in a disperse manner. The ASIC 302 performs exposure timing controls on the first image sensor 312 and the second image sensor 412 such that the analog signal units of the first side data and the second side data may be sequentially and alternately outputted. First, the first image sensor 312 senses the 1^{st} first optical signal unit of the first side data at T₂=0, and then the second image sensor 412 senses the 1^{st} second optical signal unit of the second side data at T₂=s₂. At T₂=t₂, the first image sensor 312 finishes sensing the 1^{st} first optical signal unit, and starts to shift out the 1^{st} first signal charge A₂₁. In order to make the first signal charge and second signal charge be sequentially and alternately outputted, the first image sensor 312 does not sense a next optical signal unit immediately, but continues to sense the 2^{nd} first optical signal unit of the first side data at T₂=3s₂ after a period of time of 2ₛ₂−t₂ has elapsed. At T₂=t₂+s₂, the first image sensor 312 finishes shifting out the 1^{st} first signal charge A₂₁. At this time, the second image sensor 412 just finishes sensing the 1^{st} second optical signal unit, so the second image sensor 412 then shifts out the 1^{st} second signal charge B₂₁. Similarly, he second image sensor 412 does not continue to sense a next optical signal unit, but continues to sense the 2^{nd} second optical signal unit of the second side data at T₂=3s₂ after a period of time of 2s₂−t₂ has elapsed, such that the first signal charges and second signal charges can be continuously, sequentially and alternately outputted. At T₂=t₂+2s₂, the second image sensor 412 finishes shifting out the 1^{st} second signal charge B₂₁. At this time, sensing the 2^{nd} first optical signal unit of the first side data has been just finished, so the first image sensor 312 shifts out the 2^{nd} first signal charge A₂₂ immediately.

In the third preferred embodiment, the exposure time (t₂) of the sensor of the image capturing device is smaller than twice the shift-out time (s₂) of the signal charges, so two signal charges cannot be shifted out within the exposure time of one optical signal unit. In this case, using the ASIC 302 to respectively perform the exposure timing controls on the first image sensor 312 and the second image sensor 412 and to pause the sensing at T₂=[t₂+(m−1)s₂, (m+1)s₂] and T₂=[t₂+ms₂, (m+2)s₂] can make the first signal charges and second signal charges be continuously, sequentially and alternately outputted without being temporarily stored into the memory. That is, the first image sensor 312 finishes sensing the m^{th} first optical signal unit at T₂=t₂+(m−1)s₂ and again continues to sense the (m+1)^{th} first optical signal unit of the first side data at T₂=(m+1)s₂ after the waiting time of 2s₂−t₂ has elapsed. Similarly, the second image sensor 412 finishes sensing the m^{th} second optical signal unit at T₂=t₂+ms₂, and again continues to sense the (m+1)^{th} second optical signal unit of the second side data at T₂=(m+2)s₂ after the waiting time of 2s₂−t₂ has elapsed.

In the exposure timing control method of ASIC, an electronic shuttle (or photo shutter, or clear gate) 512 device may be used to control the starting timing of exposure of the image sensor. As shown in FIG. 3, the principle of the electronic shuttle 512 is to provide the phase signals F1 and F2 on the photo sensors D1 to D8. Before the exposure is started, the phase signal is a positive voltage to disable the photo sensor from accumulating charges. When the exposure is started, the phase signal is a negative voltage, and the photo sensor starts to accumulate charges. Alternatively, before the exposure is started, the electronic shuttle 512 is controlled to be in the grounded state to disable the photo sensor from accumulating charges. When the exposure is started, the electronic shuttle turns into a non-grounded state, and the photo sensor starts to accumulate charges. In addition, if a device similar to the shift gate 512 is added to the other side of the photo sensors D1 to D8 and connected to the control circuit 504, the above-mentioned exposure timing control also may be performed.

Because the photo sensor is gradually miniaturized, the exposure area is reduced. In addition, in order to achieve the desired exposure effect, the exposure time has to be lengthened. More particularly, the long exposure time limits the scanning speed in the high-resolution scanner, and the length of the exposure time still relates to the lamp brightness, the sensitivity of the photo sensor and the system requirement. The prior art adopting two scanning devices cannot improve the condition of long exposure time in the high-resolution scanner, but only increases the cost without increasing the scanning speed.

The image capturing device with duplex scan function according to the embodiments of the invention can perform the exposure timing control on the image sensor and output data in subdivisions, such that the first side data and the second side data are sequentially and alternately outputted as the first digital signal units and the second digital signal units. Thus, it is unnecessary to provide the memory for temporarily storing scanning data and no need to use two A/D converters simultaneously. More particularly, in the first or second embodiment, the exposure time (t) of the optical signal equals twice the shift-out time (s) of the signal charges. So, the number of electrical elements and the total cost may be reduced without influencing the scanning speed.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An image capturing device with duplex scan function, for scanning a to-be-scanned document, which has a first side data and a second side data, the image capturing device comprising:
a first image sensor for sensing a first optical signal unit of a first optical signal of the first side data and generating a corresponding first analog signal unit of a first analog signal, wherein a plurality of the first optical signal units constitute the first optical signal and a plurality of the first analog signal units constitute the first analog signal;
a second image sensor for sensing a second optical signal unit of a second optical signal of the second side data and generating a corresponding second analog signal unit of a second analog signal, wherein a plurality of the second optical signal units constitute the second optical signal and a plurality of the second analog signal units constitute the second analog signal;
a multiplexer for selecting the first analog signal unit or the second analog signal unit;
an A/D converter for converting the selected first analog signal unit into a first digital signal unit, or converting the selected second analog signal unit into a second digital signal unit; and
an ASIC (Application Specific Integrated Circuit) for controlling exposure timings of the first image sensor and the second image sensor and for controlling the first image sensor and the second image sensor to sequentially and alternately output the first analog signal unit and the second analog signal unit.

2. The device according to claim 1, wherein the exposure timings are controlled according to a relationship between exposure time and shift-out time of the first image sensor and the second image sensor.

3. The device according to claim 2, wherein the exposure time equals twice the shift-out time.

4. The device according to claim 3, wherein the first image sensor and the second image sensor respectively and continuously sense the first optical signal units and the second optical signal units until the first side data and the second side data have been completely captured.

5. The device according to claim 2, wherein the exposure time is longer than twice the shift-out time.

6. The device according to claim 5, wherein the first image sensor and the second image sensor respectively and continuously sense the first optical signal units and the second optical signal units until the first side data and the second side data have been completely captured.

7. The device according to claim 2, wherein the exposure time is shorter than twice the shift-out time.

8. The device according to claim 7, wherein the first image sensor and the second image sensor respectively and discontinuously sense the first optical signal units and the second optical signal units.

9. The device according to claim 1, wherein the first optical signal unit contains data of a scan line of the first side data.

10. The device according to claim 1, wherein the second optical signal unit contains data of a scan line of the second side data.

11. The device according to claim 1, wherein the first image sensor is mounted on a scanner body.

12. The device according to claim 1, wherein the second image sensor is mounted on an ADF (Automatic Document Feeder).

13. The device according to claim 1, wherein the first image sensor and the second image sensor are CCD (Charge-Coupled Device) sensing devices.

14. An image capturing method for duplex scanning a first side data and a second side data of a to-be-scanned document by using an exposure timing control, the method comprising the steps of:
sensing a first optical signal unit of a first optical signal of the first side data and sensing a second optical signal unit of a second optical signal of the second side data according to a relationship between exposure time and shift-out time, wherein a plurality of the first optical signal units constitute the first optical signal and a plurality of the second optical signal units constitute the second optical signal;
converting the first optical signal unit and the second optical signal unit into a first analog signal unit of a first analog signal and a second analog signal unit of a second analog signal, respectively, wherein a plurality of the first, analog signal units constitute the first analog signal and a plurality of the second analog signal units constitute the second analog signal;
sequentially and alternately converting the first analog signal unit and the second analog signal unit into a first digital signal unit and a second digital signal unit; and
sequentially and alternately outputting the first digital signal unit and the second digital signal unit.

15. The method according to claim 14, wherein the first optical signal unit contains data of a scan line of the first side data.

16. The method according to claim 14, wherein the second optical signal unit contains data of a scan line of the second side data.

17. The method according to claim 14, wherein the exposure time equals twice the shift-out time.

18. The method according to claim 1/4, wherein the exposure time is longer than twice the shift-out time.

19. The method according to claim 14, wherein the exposure time is smaller than twice the shift-out time.
